(19) United States
(12) Patent Application Publication
(10) Pub. No.: US 2013/0160080 A1
(43) Pub. Date: Jun. 20, 2013

(54) APPARATUS AND METHOD FOR VERIFYING APPLICATION USER

(71) Applicant: Samsung Electronics Co., Ltd., Gyeonggi-do (KR)

(72) Inventors: Jae-Young Shin, Seoul (KR); Young-Hwan Ryu, Gyeonggi-do (KR)

(73) Assignee: Samsung Electronics Co., Ltd., Gyeonggi-do (KR)

(21) Appl. No.: 13/715,147

(22) Filed: Dec. 14, 2012

(30) Foreign Application Priority Data
Dec. 14, 2011 (KR) 10-2011-0134688

(51) Int. Cl. H04L 29/06

(52) U.S. Cl. CPC H04L 63/08
USPC 726/3

(57) ABSTRACT

Apparatus and a method for verifying application users includes an application installed in user equipment, a communication unit configured to communicate to verify a user of the application, and a control unit configured to select a user verification type for the application from a plurality of user verification types, based on a predetermined condition, and control the communication unit based on the selected user verification type to perform user verification. The apparatus and method provide a number of types of verification against various cases which wound otherwise allow no verification, depending on whether SMS messages can be transmitted, application provider policies, etc., so that users of applications can be verified in a fast and convenient manner.

### PRIORITY

This application claims priority under 35 U.S.C. §119(a) to a Korean Patent Application filed in the Korean Industrial Property Office on Dec. 14, 2011 and assigned Serial No. 10-2011-0134688, the contents of which are incorporated herein by reference.

### BACKGROUND OF THE INVENTION

1. Field of the Invention

The present invention relates generally to an apparatus and a method for verifying an application user, and more particularly to an apparatus and a method for verifying a user of an application through user equipment.

2. Description of the Related Art

Recently, appreciation and availability of user equipment such as smart phones has been increasing, followed by widespread use of applications through the user equipment, along with an exponential increase in the number and types of applications that can be executed by the user equipment.

Generally, a user downloads a desired application from a server that provides various applications, for example through an application store, to the user equipment, installs the application, and uses it. The installed application can only be used by a verified user, i.e. after the user is verified as the legitimate user of the application.

There are a number of methods for verifying application users, and one of the conventional methods is to use the phone number assigned to the user equipment. Specifically, there are two types of Short Message Service (SMS) methods for verification based on the phone number of user equipment: a self-SMS type and a non-self-SMS type.

In the self-SMS-type verification method, the user equipment sends a text for verification to its own phone number using an SMS, and then receives the text for verification sent by itself The transmitted text message for verification includes an encrypted verification code, which is used by the user equipment to go through user verification.

In the non-self-SMS type verification method, the application server transmits a verification code to the user equipment, which then receives and uses it to go through user verification. The user equipment receives a verification code from the application server and performs user verification using the verification code.

However, the self-SMS-type verification method is problematic in that it cannot be used for example, when the equipment cannot transmit an SMS text due to unavailability of a Wi-Fi communication tablet or the service itself, or when SMS transmission is impossible, even if the equipment is capable of such transmission, because the field strength is weak (i.e. poor network conditions). In addition, the self-SMS-type verification method is also inapplicable to electronic equipment having a platform that only allows use of a verification number from the server, for example, iOS platforms or BlackBerry platforms.

The non-self-SMS-type verification method has a problem in that the user needs to re-enter the verification code in the received short message. Furthermore, the fact that simple verification codes are commonly used because users tend to avoid entering complicated verification codes makes this method vulnerable to code stealing and compromises security.

However, most applications adopt either the above-mentioned self-SMS type or the non-self-SMS type of user verification and when the user equipment supports only one of the self-SMS type and non-self-SMS type, it is impossible to install and use any application that requires user verification of an unsupported type.

### SUMMARY OF THE INVENTION

Accordingly, the present invention has been made to solve the above-stated problems and disadvantages occurring in the prior art, and to provide at least the advantages described below. Accordingly, an aspect of the present invention provides an apparatus and a method for verifying users of applications in a number of types against various cases that would otherwise allow no verification.

Another aspect of the present invention provides an apparatus and a method for verifying users of applications, which support both the self-SMS type and the non-self-SMS type.

According to an aspect of the present invention, there is provided an application user verification apparatus including an application installed in user equipment, a communication unit adapted to communicate to verify a user of the application, and a control unit adapted to select a user verification type for the application from a plurality of user verification types, based on a predetermined condition, and control the communication unit based on the selected user verification type to perform user verification.

According to another aspect of the present invention, there is provided an application user verification method including selecting a user verification type for the application from a plurality of user verification types based on a predetermined condition, and performing user verification in the selected user verification type.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating the construction of an application user verification system according to an embodiment of the present invention;

FIG. 2 is a diagram illustrating the construction of user equipment according to an embodiment of the present invention;

FIG. 3 is a flowchart of a method for verifying application users by user equipment according to an embodiment of the present invention;

FIGS. 4A to 4E are diagrams illustrating images displayed on the screen of user equipment when user verification is performed in the self-SMS type according to an embodiment of the present invention; and

FIGS. 5A to 5D are diagrams illustrating images displayed on the screen of user equipment when user verification is performed in the non-self-SMS type according to an embodiment of the present invention.

### DETAILED DESCRIPTION OF THE EMBODIMENTS OF THE PRESENT INVENTION

Hereinafter, various embodiments of the present invention are described in detail with reference to the accompanying drawings. In the following description, a detailed description of well-known functions and structures will be omitted to avoid obscuring the subject matter of the present invention.

User equipment includes equipment that can download and install applications, such as mobile phones, tablets, computers, Internet Protocol TeleVision (IPTV), etc., and performs user verification in a number of types against various cases that would otherwise allow no verification. Specifically, the method for verifying application users according to the present invention supports both self-SMS type and non-self-SMS type and enables the user equipment to verify the user of an application in a possible type selected between the self-SMS-type and the non-self-SMS type according to a predetermined condition.

Applications include various programs or services executable by user equipment. Examples of applications include camera driving applications, game applications, communication service applications, message applications, and the like, where user equipment includes equipment that can download, install, and execute an application, and an application can be installed in user equipment and executed by it. In the following description, the user equipment is a smart phone, and the application is a messenger service application.

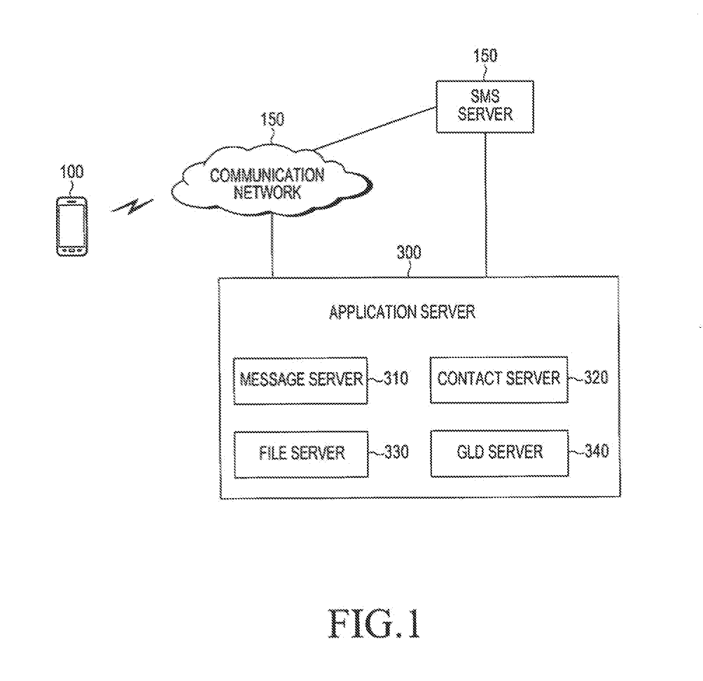

FIG. 1 is a diagram illustrating an application user verification system according to an embodiment of the present invention. Referring to FIG. 1, the application user verification system includes user equipment 100, an SMS server 200, and an application server 300.

The user equipment 100 is for example a smart phone. When an application installed in the user equipment 100 requests user verification, the user equipment 100 selects a user verification type and performs user verification. The application is downloaded from a server, which provides various applications (e.g. application store), to the user equipment 100 at the user's request and installed. Alternatively, the user equipment may have a pre-installed application.

The SMS server 200 provides an SMS and, when the user equipment 100 or the application server 300 requests transmission of an SMS message for application user verification, transmits the SMS message to the corresponding phone number.

The application server 300 performs provisioning and user verification, as necessary to use an application installed in the user equipment 100. Provisioning refers to an initialization procedure of the user equipment 100 to exchange information necessary to receive the corresponding application service from the application server 300.

The application server 300 performs provisioning and user verification and communicates with the application via user equipment 100 to provide a service corresponding to the application. The application server 300 is a server for providing various types of applications, including a game application, a moving picture application, a chatting application, a messenger application, etc., and it will be assumed in the description of an embodiment of the present invention that the application server 300 is a messenger application server.

The application server 300, configured as a messenger application server, includes a message server 310, a contact server 320, a file server 330, and a Global Load Distribution (GLD) server 340. The message server 310 is configured to enable the user equipment 100 to exchange messages with other equipment. The contact server 320 is configured to store the list of buddies of messenger application users and at the request of the user equipment 100, connect the user equipment with the desired buddy. The file server 330 is configured to store files necessary for the messenger service (e.g. photos, moving pictures) and to provide the files. The GLD server 340 is configured to communicate with the messenger application of the user equipment 100, manage addresses, and process location-based load distribution.

When a messenger application is installed in the user equipment 100, and when the user enters a request for the messenger application to be executed initially, the application server 300 communicates with the user equipment 100 to perform provisioning for executing the messenger application and perform user registration. The user equipment 100 then performs user verification in the user registration process.

The application server 300 begins the provisioning process, when the user enters a request to initially execute a messenger application using the user equipment 100, and the user equipment 100 transmits, in addition to a request to receive the messenger application service, the International Mobile Equipment Identify (IMEI), the phone number, and the International Mobile Subscriber Identify (IMSI) to the GLD server 340 of the application server 300.

The GLD server 340, based on the information from the user equipment 100, provides the user equipment 100 with information regarding whether the messenger application service is possible and the Mobile Station International ISDN Number (MSISDN). Alternatively, the MSISDN may be already held by the user equipment 100 or generated by it. It is also possible that the GLD server 340 generates the MSISDN using the phone number and the country calling code provided by the messenger application of the user equipment 100, and provides the user equipment 100 with the MSISDN.

Based on the MSISDN obtained through the provisioning process for receiving the messenger application service, the user equipment 100 performs user registration and performs user verification through the user registration process. Although in this description it is assumed that the MSISDN is received from the application server 300 to perform user verification in the user registration process, it is also possible that the user equipment 100 already has the MSISDN or obtains it in another manner, or that user verification is performed regardless of the provisioning or user registration process.

In the following description it is assumed that the user equipment 100 performs user verification in the user registration process, and that the user equipment 100 interworks with the SMS server 200 or the application server 300, during user verification, to select between the self-SMS type and the non-self-SMS type, based on a predetermined criterion, and perform user verification in the selected type. The predetermined criterion includes determination whether SMS messages can be transmitted, and application provider policies, and the like.

Determination whether SMS messages can be transmitted involves user equipment 100 that cannot receive the SMS, user equipment 100 that can receive the SMS but can transmit no SMS message to its own number, and the like. The application provider policies are determined in connection with whether the corresponding application provider allows only the self-SMS type or only the non-self-SMS type.

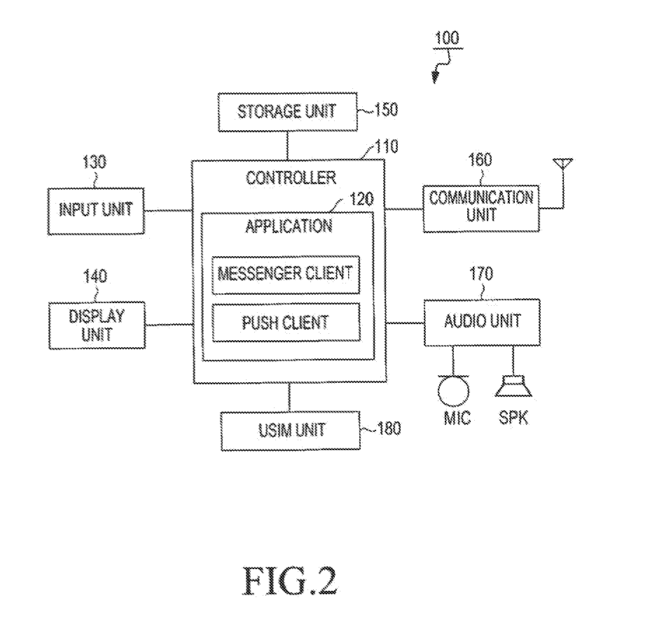

The construction of user equipment 100 according to an embodiment of the present invention, which is configured to perform user verification as describe above, is described with reference to FIG. 2. Referring to FIG. 2, the user equipment 100 includes a control unit 110, an input unit 130, a display unit 140, a storage unit 150, a communication unit 160, an audio unit 170, and a USIM unit 180.

The input unit 130 consists of a keypad or a touch screen, for example, which has a combination of a number of keys for entering various numerals, characters, marks, and user commands. According to an embodiment of the present invention, the input unit 130 receives the user's request to execute an application and delivers it to the control unit 110, or delivers various types of data necessary for user verification, entered by the user, to the control unit 110.

The display unit 140 includes a Liquid Crystal Display (LCD), an Organic Electro-Luminescence Display (OELD), etc., and is configured to display the operation or condition of the user equipment 100 on the screen under the control of the control unit 110. Specifically, the display unit 140 displays images for user verification, according to an embodiment of the present invention.

The storage unit 150 includes a non-volatile memory, such as a flash memory, a hard disk, and the like., and is configured to store data or programs necessary for operation of the user equipment 100.

The communication unit 160 is configured to communicate under the control of the control unit 110, and the content and usage of communication varies depending on the application or function executed by the user equipment 100. For example, when the user equipment 100 is conducting a communication function, the communication unit 160 performs telephone communication with the communicating party. When the user equipment 100 is performing the Internet function, the communication unit 160 conducts Internet communication to transmit/receive data. The type of communication of the communication unit 160 includes 3G, Wi-Fi, or Bluetooth® communication, which can be selected and used under the control of the control unit 110, as well as other types of communication not mentioned herein. According to an embodiment of the present invention, the communication unit 160 communicates with the SMS server 200 and the application server 300 under the control of the control unit 110 during user verification.

The audio unit 170 is configured to conduct various types of audio processing under the control of the control unit 110, convert audio signals inputted through the microphone MIC into digital audio information and transmit it to the control unit 110, and convert digital audio information, which is generated by the application or other functions executed by the user equipment 100, into analog audio signals and output them through the speaker (SPK).

The Universal Subscriber Identify Module (USIM) unit 180 is configured to store personal information for providing the subscriber with various services including verification, accounting, security, and the like. The USIM unit 180 is configured to store International Mobile Subscriber Identify (IMSI) for user verification and provide the IMSI under the control of the control unit 110.

The control unit 110 is configured to control the operation of each component of the user equipment 100 described above, and has a control program for controlling the operation of each component of the user equipment 100. The control program includes a messenger application 120, which is transmitted, downloaded, and installed from an external source (e.g. application store) through the communication unit 160, or pre-installed when the user equipment 100 is manufactured. Although a messenger application is installed, as described herein, the control program may also include a plurality of applications of other kinds. When a messenger application is included, it includes a messenger client 122 and a push client 124. The messenger client 122 is configured to communicate with the application server 300 to perform a messenger application service. The push client 124 is configured to receive a push message generated by the application server 300 through a push server (not shown) and provide the messenger client 122 with the message, so that the message is delivered from the application server 300 to the messenger client 122.

According to an embodiment of the present invention, the control unit 110, which has a messenger application installed including a messenger client 122 and a push client 124, performs user verification during provisioning and user registration at the user's request for initial execution of the messenger application.

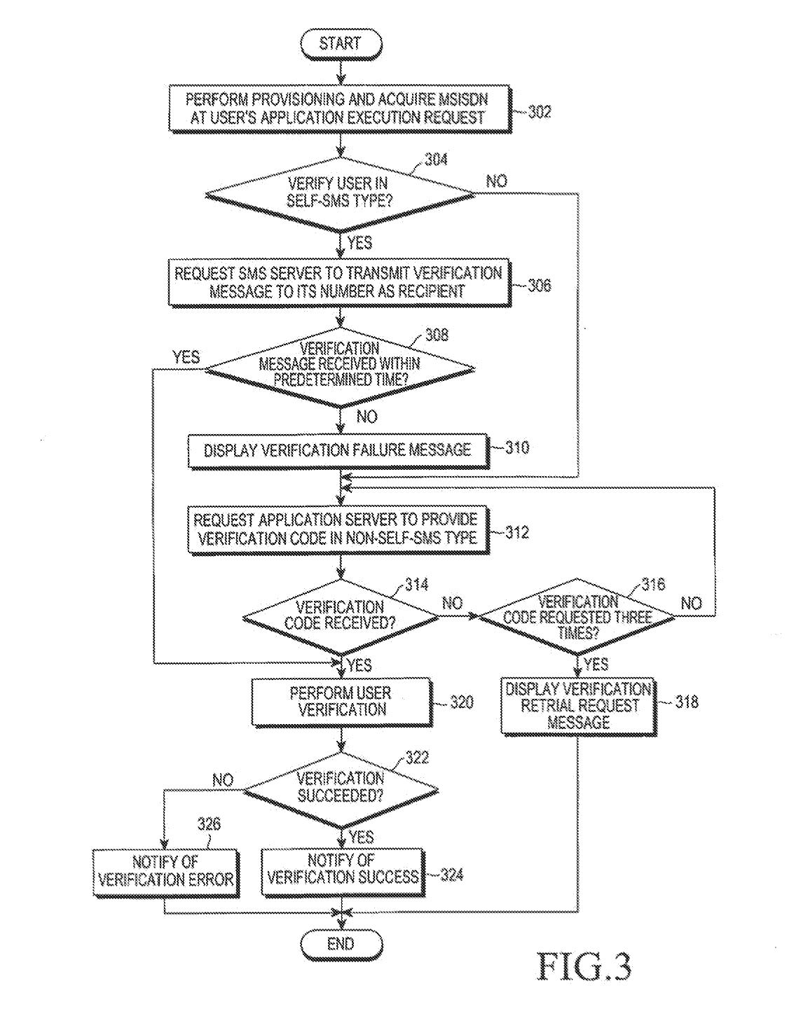

A user verification process for receiving a messenger application service by user equipment 100 of the above-mentioned construction is described in detail below. FIG. 3 is a flowchart of a user verification process for receiving a messenger application service by user equipment 100 according to an embodiment of the present invention. Referring to FIG. 3, the control unit 110 of the user equipment 100 performs provisioning for receiving a messenger application service at the user's request to execute the messenger application initially, which is entered through the input unit 130, and acquires the MSISDN for user verification Step in Step 302.

During the provisioning, the control unit 110 sends a request for the messenger application service to the application server 300, i.e. GLD server 340, through the communication unit 160 and transmits the IMEI of the user equipment 100, the phone number, and the IMSI stored in the USIM unit 180. The GLD server 340 then can determine whether the messenger application service is possible for the user equipment 100 based on the IMEI, the phone number, and the IMSI and provide the user equipment 100 with the MSISDN.

The control unit 110 acquires the MSISDN, which is necessary for user verification by the GLD server 340, through the provisioning It is also possible to generate the MSISDN by itself or use a pre-stored MSISDN.

After the provisioning, the control unit 110 enters into a user registration process Step in Step 304 and determines in which type user verification is to be performed. For example, the control unit 110 determines whether user verification is to be performed in the self-SMS type. The control unit 110 can determine the user verification type based on a predetermined criterion, including determination whether SMS messages can be transmitted, application provider polities, etc. Determination whether SMS messages can be transmitted involves user equipment 100 that cannot receive the SMS, user equipment 100 that can receive the SMS but can transmit no SMS message to its own number, etc. The application provider policies can be determined in connection with whether the corresponding application provider allows only the self-SMS type or only the non-self-SMS type. It is also possible that, without determining whether user verification is to be performed in the self-SMS type, the self-SMS type is already adopted for user verification.

When the self-SMS type is chosen for user verification, the control unit 110 sends a request, via the communication unit 160, to the SMS server 200 that a verification message be transmitted to the phone number of the user equipment 100 as the recipient Step in Step 306. The control unit 110 determines whether the verification message is received within a predetermined period of time Step in Step 308. When the verification message is received within the predetermined time, the control unit 110 proceeds to Step 320 and performs user verification. If no verification message is received within the predetermined time, the control unit 110 proceeds to Step 310, displays a verification failure message, and proceeds to Step 312.

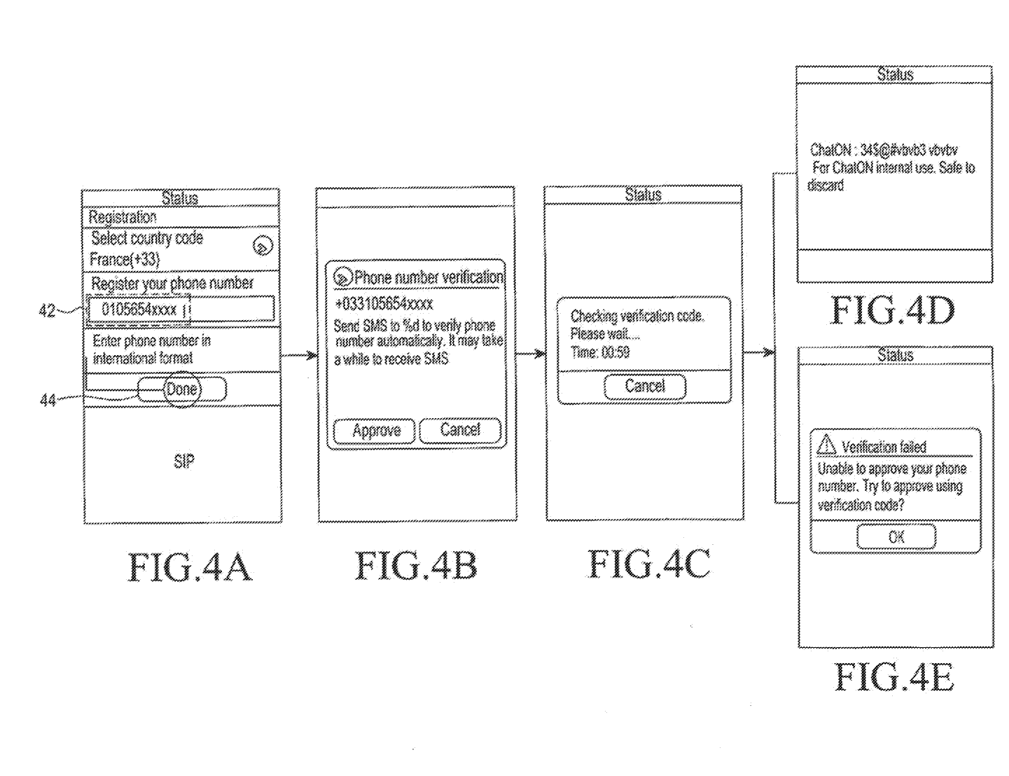

FIGS. 4A to 4E are diagrams illustrating images displayed on the screen of user equipment 100 when user verification is performed in the self-SMS type according to an embodiment of the present invention. Referring to FIG. 4A, when the self-SMS type is chosen for user verification, the control unit 110 controls the display unit 140 to display an input image, as illustrated in FIG. 4A, so that the phone number 42 of the user equipment 100 can be entered. The user enters the phone number of the user equipment 100, as indicated by ‘010-5654-xxxx’, and presses the button ‘Done’ 44. The control unit 110 then requests the SMS server 200 to transmit a verification message to the phone number of the user equipment 100 as the recipient. In this case, a notice indicating that the verification message will be received for verification can be displayed as illustrated in FIG. 4B. When the user selects ‘Approve’ and allows user verification in the self-SMS type, the control unit 110 waits for the verification message to be received as illustrated in FIG. 4C. The period of time to wait for the verification message to be received is one minute. When the verification message is received within one minute, the control unit 110 can receive the verification message and perform verification as illustrated in FIG. 4D. For example, the verification message includes a six-digit verification code, or a 32-digit encrypted verification code. When no verification message is received within one minute, the control unit 110 can display a verification failure message as illustrated in (e) of FIG. 4E. Referring to FIGS. 4A to 4E, the verification failure message of the self-SMS type contains a question whether a verification code of the non-self-SMS type is to be requested, and the user can request user verification of the non-self-SMS type as a response to the question.

When user verification of the self-SMS type has failed, as described above, or when user verification of the self-SMS type has not been selected, the control unit 110 requests the application server 300 to provide a verification code in the non-self-SMS type in Step 312. The control unit 110 then determines whether the verification code is received for a predetermined period of time in Step 314. When no verification code is received for the predetermined period of time, the control unit 110 proceeds to Step 316 and determines whether a verification code request is made n times. When the verification code request is made three times (assuming n=3), the control unit 110 proceeds to Step 318 and displays a verification retrial request message. When a request is made within three trials, the control unit 110 returns to Step 312 and again requests the application server 300 to provide the verification code.

When it is determined in Step 314 that the verification code has been received, the control unit 110 performs user verification in Step 320 using the received verification code. The control unit 110 determines in Step 322 whether verification has succeeded. When verification has succeeded, the control unit 110 notifies of verification success in Step 324 and, when failed, notifies of verification error in Step 324.

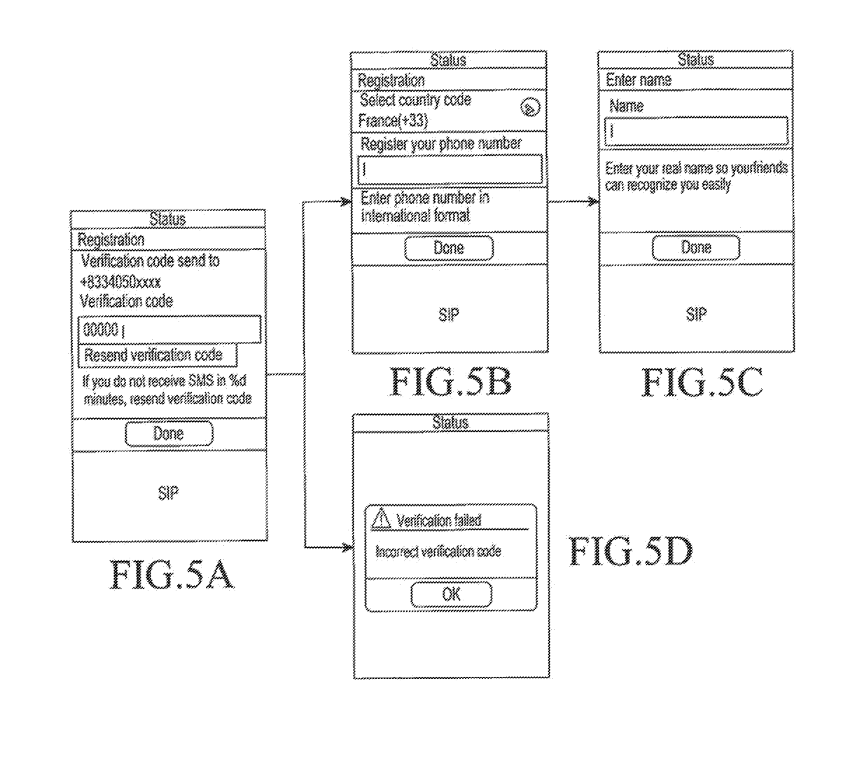

FIGS. 5A to 5D are diagrams illustrating images displayed on the screen of user equipment 100 when user verification is performed in the non-self-SMS type according to an embodiment of the present invention. Referring to FIG. 5A, when it has been determined to perform user verification in the non-self-SMS type, the control unit 110 controls the display unit 140 to display an image, as illustrated in FIG. 5A, so that a verification code from the application server 300 can be entered. The verification code from the application server 300 is carried by an SMS message, automatically entered on the verification code entering image, or manually entered by the user on the verification code entering image. User verification is performed after the verification code is entered on the verification code entering image. When user verification using the verification code fails, the control unit 110 displays a message notifying of failure of user verification using the verification code, as illustrated in FIG. 5D. When user verification using the verification code succeeds, the control unit 110 displays a user phone number entering image, as illustrated in FIG. 5B, and receives the user's phone number. The control unit 110 then displays a user name entering image, as illustrated in FIG. 5C, and receives the user's name to perform user registration.

As described above, the present invention supports both the self-SMS type and the non-self-SMS type when the user equipment 100 verifies the user of an application. This is advantageous in that, even if the user equipment 100 supports only the self-SMS type or only the non-self-SMS type, it can still use an application that requires user verification in the other type. The present invention provides a number of types of verification against various cases which would otherwise allow no verification, depending on whether SMS messages can be transmitted, application provider policies, and the like., so that users of applications can be verified in a fast and convenient manner.

Although embodiments of the present invention have been described with regard to a messenger application, the apparatus and method for verifying users of applications is applicable to a wide range of applications. In addition, although it has been assumed that user verification is performed during provisioning and user registration, user verification can be performed in other ways.

While the present invention has been described with reference to various embodiments thereof, it will be understood by those skilled in the art that various changes in form and detail may be made without departing from the spirit and scope of the invention as defined by the appended claims.

What is claimed is:

1. An application user verification apparatus comprising:
an application installed in user equipment;
a communication unit configured to communicate to verify a user of the application; and
a control unit configured to select a user verification type for the application from a plurality of user verification types, based on a predetermined condition, and control the communication unit based on the selected user verification type to perform user verification.

2. The application user verification apparatus as claimed in claim 1, wherein the plurality of user verification types includes a self-SMS type and a non-self-SMS type.

3. The application user verification apparatus as claimed in claim 1, wherein the predetermined condition is determined by whether SMS messages can be transmitted and application provider policies.

4. The application user verification apparatus as claimed in claim 2, wherein the control unit is configured to perform user verification in the user verification type of the self-SMS type and, when user verification fails, to perform user verification in the non-self-SMS type.

5. An application user verification method, the method comprising:
selecting a user verification type for an application from a plurality of user verification types based on a predetermined condition; and
performing user verification in the selected user verification type.

6. The application user verification method as claimed in claim 5, further comprising performing user verification, when user verification in the selected user verification type fails, in a user verification type different from the selected user verification type.

7. The application user verification method as claimed in claim 5, wherein the plurality of user verification types include a self-SMS type and a non-self-SMS type.

8. The application user verification method as claimed in claim 5, wherein the predetermined condition is determined by whether SMS messages can be transmitted and application provider policies.
